(19) United States
(12) Patent Application Publication
(10) Pub. No.: US 2001/0053338 A1
(43) Pub. Date: Dec. 20, 2001

(54) CONTROL SYSTEM FOR CONTINUOUS POLYAMIDATION PROCESS

(76) Inventors: GREGORY E. BUSH, PENSACOLA, FL (US); CHRIS E. SCHWIER, PENSACOLA BEACH, FL (US); ROBERT M. LEMBCKE, PENSACOLA, FL (US); STEVEN W. COOK, PENSACOLA, FL (US)

Correspondence Address: CRAIG M LUNDELL, ARNOLD WHITE & DURKEE, P O BOX 4433, HOUSTON, TX, 772104433

(21) Appl. No.: 09/320,078

(22) Filed: May 26, 1999

(51) Int. Cl. G05D 11/08

(52) U.S. Cl. 422/110; 422/108; 422/105

(57) ABSTRACT

An improved polyamidation system and control system for producing a polyamide from molten dicarboxylic acid monomer and molten diamine monomer. The polyamidation control system measures the molar ratio of the molten dicarboxylic acid monomer and molten diamine monomer with a partially polymerized mixture. A feed forward control algorithm is employed within the control system to determine the extent to which the ratio of the initial reactants must be altered prior to mixing in order to produce the resulting polyamide having stoichiometrically balanced molar ratio.

### BACKGROUND OF THE INVENTION

I. Field of the Invention

The present invention relates generally to processes for producing polyamides from dicarboxylic acid monomers and diamine monomers. More particularly, the invention relates to an improved polymerization system and control system therefor which maintains a desired mass flow rate of molten reactants by measuring the molar ratio of the reactants after the initiation of polymerization and adjusting the flow rate of the molten reactant feed stocks.

II. Discussion of the Prior Art

A major challenge in the manufacture of polyamides is ensuring that reactants are provided in amounts sufficient to balance the number of carboxylic and amine end groups in the resulting polyamide. If the reactants combine such that an excess of carboxylic or amine end groups remain, it can negatively influence certain characteristics of the resulting polyamide. For example, when producing nylon 6, 6 from adipic acid and hexamethylenediamine (HMD), it is found that an end group imbalance can adversely affect the dyeability of the nylon, as well as curtail the ability to make nylon 6, 6 of high molecular weight. As a result, manufacturers have placed an emphasis on balancing the molar ratio of the reactants during polymerization in the interest of maximizing the quality of polyamides.

One prior art technique for producing polyamides involves a two-step process in which a dicarboxylic acid and a diamine are reacted in water to form a salt, and then the salt is heated to cause polymerization. This two-step polymerization process is disadvantageous, however, in that it requires the addition of water and the use of evaporation chambers to remove the water added when forming the salt. It is also difficult to control the process to ensure proper molar balance in the end polymer because the evaporation chambers are very unpredictable and hard to model.

A variety of control mechanisms have been employed in this two-step polymerization process. One known control mechanism involves physically removing a sample of the in-process material for end group analysis. This is disadvantageous, however, in that it is time consuming to perform and tends to introduce inaccuracy because the samples do not always adequately reflect the characteristics of the in-process materials.

Other known control mechanisms involve conducting an in-line end group analysis in an effort to provide proper molar balance in the resulting polyamide. These in-line control mechanisms are helpful in terms of avoiding the need to physically sample the in-process materials. One technique involves an indirect assessment of molar balance by measuring the pH of the salt formed in the two-step polymerization process. This pH measuring technique is limited, however, because pH is not a particularly accurate indicator of end group balance in the resulting polyamide.

Another in-line end group analysis technique involves measuring the end-group ratio during polymerization and, based on this determination, injecting an appropriate amount of reactant into the molten polymerization mixture to provide a desired molar balance in the resulting polyamide. This system is disadvantageous in that it requires costly additional metering devices and circuitry to inject additional reactant into the molten polymerization mixture. This system is also limited in that it requires additional time for the subsequently added reactants to combine with the molten polymerization mixture.

Attempts have been made to produce polyamides directly from the monomers without adding water. Controlling the degree to which the reactants combine has proven to be quite difficult, however, because an excess of one or the other will adversely affect the molecular weight and thus the physical properties of the product. Other problems with such direct polymerization processes include degradation of the monomers and/or the polymer product as a result of (1) being kept at high temperatures for lengthy periods of time (e.g., several hours), (2) contact of the molten monomer with oxygen, and (3) exposure to trace metal impurities in the materials from which the process equipment is made.

There is a long-standing need for an improved polymerization system and control system therefor which overcome the aforementioned drawbacks in the prior art.

### SUMMARY OF THE INVENTION

One aspect of the invention is an improved polymerization system for producing a polyamide from a dicarboxylic acid monomer and a diamine monomer. First metering means are provided for metering a supply of molten dicarboxylic acid monomer. Second metering means are provided for metering a supply of molten diamine monomer. The first and second metering means are coupled together such that the supply of molten dicarboxylic acid monomer and the supply of molten diamine monomer combine to form a molten polymerization mixture. At least one unvented reaction vessel is provided for polymerizing the polymerization mixture. Means are provided for detecting the molar ratio of molten dicarboxylic acid monomer and molten diamine monomer in the polymerizing mixture. Control means are communicatively coupled to the means for detecting and the first and second metering means. The control means selectively adjusts the mass flow rate of at least one of the supply of molten dicarboxylic acid monomer and the molten diamine monomer to balance the molar ratio of molten dicarboxylic acid monomer and molten diamine monomer in the polymerization mixture.

Another aspect of the present invention is a polymerization control system for producing a polyamide from dicarboxylic acid monomer and diamine monomer. First means are provided for metering a supply of molten dicarboxylic acid monomer. Second means are provided for metering a supply of molten diamine monomer into the supply of molten dicarboxylic acid monomer to form a molten polymerization mixture. Means are provided for detecting the molar ratio of the molten dicarboxylic acid monomer and molten diamine monomer in the polymerization mixture. A controller is provided communicatively coupled to the means for detecting and at least one of the first and second means for metering. The controller controls at least one of the first means for metering and the second means for metering based on a molar ratio input signal from the means for detecting to adjust the mass flow rate of at least one of the molten dicarboxylic acid monomer and the molten diamine monomer so as to balance the molar ratio of molten dicarboxylic acid monomer and molten diamine monomer in the polymerization mixture.

This control system operates continuously to ensure that the reactants polymerize in a balanced fashion with equal numbers of carboxylic and amine end groups in the resulting polyamide. Any modification to the flow rate of the reactants is made prior to the formation of the molten polymerization mixture. That is, the first and second metering means are adjusted to vary the mass flow rate of at least one of the molten carboxylic monomer and the molten diamine monomer. No additional dicarboxylic acid monomer or diamine monomer needs to be added after the mixing.

The control system of the present invention is particularly suited for use within a polymerization system which produces polyamides directly from the monomers. In this fashion, there is no need to add water to the dicarboxylic acid, to the diamine, or to the molten polymerization mixture.

The temperature of the polymerization mixture in the at least one unvented reaction vessel is between about 220 and about 300° C. Preferably the pressure in the at least one unvented reaction vessel is between about 0-500 psig, more preferably between about 50-250 psig, most preferably between about 120-180 psig. The residence time of the polymerization mixture in the at least one unvented reaction vessel is preferably between about 0.01 minutes and about 30 minutes, more preferably between about 0.5-30 minutes, most preferably between about 1-5 minutes. The polymerization mixture exiting the at least one unvented reaction vessel typically contains less than 40% by weight unpolymerized monomers, preferably less than 10% by weight unpolymerized monomers.

In certain embodiments, at least one vented reaction vessel may optionally be employed downstream of the at least one unvented reaction vessel for removing water formed during the polymerization process and/or for further polymerization. When so employed, the residence time of the polymerization mixture in the at least one vented reaction vessel is preferably from about 1 minute to about 60 minutes.

An offgas recovery system may also be employed for recovering vaporized diamine monomer and/or dicarboxylic acid monomer in the offgas produced by the at least one vented reaction vessel. This offgas stream typically comprises water vapor and vaporized diamine monomer. The offgas is contacted with molten dicarboxylic acid monomer in a recovery column, whereby at least a portion of the vaporized diamine monomer reacts with the dicarboxylic acid monomer to form polyamide. This serves to form a liquid effluent stream within the recovery column that comprises polyamide and unreacted molten dicarboxylic acid monomer. The liquid effluent stream may be subsequently mixed with molten diamine monomer.

In one embodiment, the relative viscosity (RV) of the nylon 6, 6 in the polymerization mixture exiting the unvented reaction vessel is between about 0 and about 3, and the relative viscosity of the nylon 6, 6 in the polymerization mixture exiting the vented vessel is between about 3 and about 15. Relative viscosity as used herein is the ratio of viscosity (in centipoises) at 25° C. of 8.4% by weight solution of polyamide in 90% formic acid (90% by weight formic acid and 10% by weight water) to the viscosity (in centipoises) at 25° C. of 90% formic acid alone.

The polyamidation process of the present invention can produce its end product without the need to add water to the reactants, and without the intermediate step of forming a salt. In addition, the process of the present invention can operate continuously and with much shorter residence times for the molten reactants and molten polymer in the high temperature portions of the process. This significantly reduces the water usage, waste water production, and energy consumption of the process. This also eliminates the need for or reduces the required size of some process equipment found in prior art processes, such as evaporators that have been used to remove the added process water. Further, excessive thermal exposure of the reactants and product is avoided.

The aspect of the present invention relating to continuous melting of dicarboxylic acid, such as adipic acid, provides a practical and economical method of continuously supplying molten dicarboxylic acid for use in a polyamidation process or for other uses. The process provides high quality molten acid without discoloration or other thermal degradation. The production of clear molten acid facilitates the production of high quality polyamide.

### BRIEF DESCRIPTION OF THE DRAWINGS

FIG. 1 is a block diagram illustrating an improved polyamidation system of the present invention;

FIG. 2 is a block diagram illustrating a polymerization control system of the present invention;

FIG. 3 is a second block diagram illustrating the polymerization control system of the present invention as shown in FIG. 2; and

FIG. 4 is a block diagram illustrating another alternative polymerization control system of the present invention.

### DESCRIPTION OF ILLUSTRATIVE EMBODIMENTS

The polymerization system and polymerization control system of the present invention can be used to produce a variety of polyamides from diacid and diamine monomers. These systems are particularly useful for producing nylon 6, 6 from adipic acid and hexamethylenediamine.

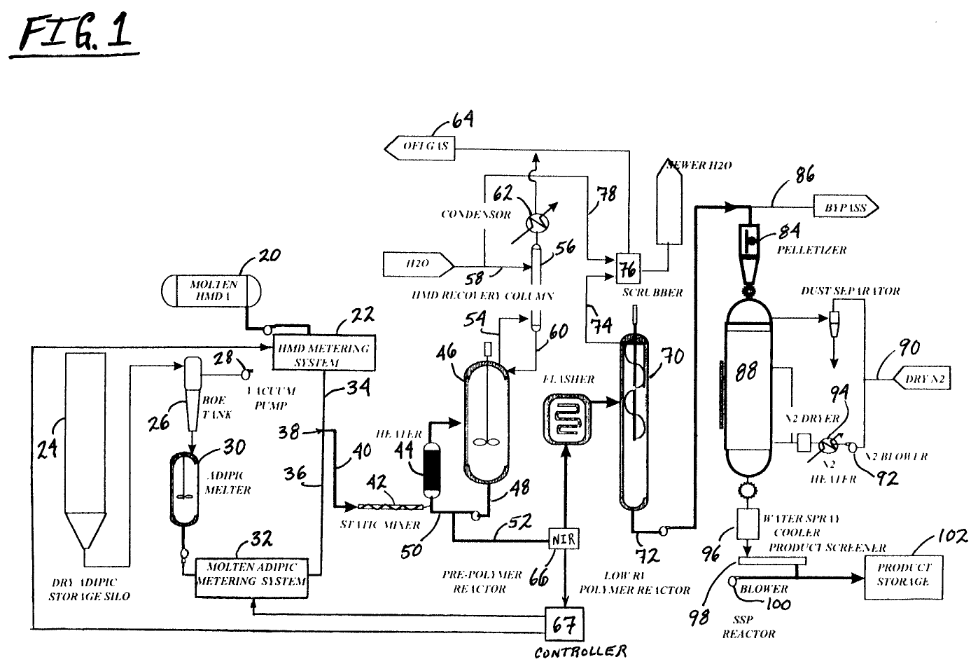

FIG. 1 shows a process flow diagram for one embodiment of the process. Molten hexamethylenediamine (HMD) is provided from a molten HMD storage tank 20. There are several suitable ways of providing the molten HMD. One is to locate the polyamidation process equipment adjacent to a plant where HMD is produced, so that a molten HMD stream can be piped directly to the tank 20. Another way would be to provide an aqueous HMD solution, evaporate the water, and melt the HMD.

Heat optionally can be applied in this tank 20, for example by means of a heat transfer jacket around the tank 20. The temperature in this tank is preferably about 70° C. The molten HMD is then pumped through an HMD metering system 22 which precisely controls the amount of HMD fed to the downstream apparatus.

Adipic acid, typically in the form of dry crystals, is supplied from an adipic acid storage silo 24. Adipic acid from the silo flows to a bulk oxygen eliminator tank 26. In this tank 26, air is removed. Preferably, removal of air in the tank 26 is accomplished by cycling vacuum with nitrogen displacement in batch mode. The vacuum can be induced by means of a vacuum pump 28. The frequency of cycling between vacuum and nitrogen pressure can be adjusted to achieve the desired level of oxygen removal.

Preferably the bulk oxygen eliminator tank 26 comprises a pressure vessel having a bottom portion forming a hopper with a diminishing diameter towards its bottom. The sides of the hopper portion of the bulk oxygen eliminator tank preferably form an angle with the horizontal of at least 70° in order to facilitate flow out of the bottom of the tank.

The adipic acid crystals, largely free of molecular oxygen, then flow (preferably by gravity, with a pressure assist by the nitrogen pressure in the bulk oxygen eliminator tank) from the bulk oxygen eliminator tank 26 to an adipic acid melter vessel 30. The melter vessel 30 preferably is a continuously stirred jacketed vessel that operates slightly pressurized with nitrogen at a temperature slightly above the adipic acid melt point (i.e., above 153° C.). Adipic acid crystals entering this vessel through its top are quickly melted at the surface of the molten adipic acid therein. Thus the process can continuously melt adipic acid. Preferably the melter vessel 30 has a reversed conical entry nozzle to reduce flow resistance. It is also preferred that the melter vessel 30 be made of a metal alloy containing little or no impurities that would adversely affect the molten monomer. Hastolloy C and 316 stainless steel are suitable materials.

It may be useful to include additional measures for further oxygen removal from this melter vessel, to minimize the potential for thermal degradation. One way of doing this is to supply vibrational energy to the molten adipic acid in the melter vessel 30, for example by means of an ultrasonic device. The vibrational energy can facilitate the escape of entrained air from the molten acid, causing air bubbles to rise to the surface of the molten acid.

The residence time of the molten adipic acid in the melter vessel 30 preferably is minimized to reduce the thermal exposure of that reactant. Preferably the residence time is less than three hours, more preferably between about 1-2 hours. The molten adipic acid exits the bottom of the melter vessel 30 and is pumped to a molten adipic acid metering system 32 which precisely controls the amount of adipic acid fed to the downstream apparatus.

The combination of the bulk oxygen eliminator tank 26 and the adipic acid melter vessel 30 permits the continuous melting of adipic acid crystals without thermal degradation or discoloration.

The HMD metering system 22 and the adipic acid metering system 32 supply the molten monomers in stoichiometric amounts such that the molten HMD and molten adipic acid are combined at a Y-junction 38 to form what will hereinafter be referred to as a “polymerization mixture.” Stated another way, the molten monomers combine and co-mingle at the Y-junction to initiate the polymerization process. The polymerization mixture progresses through the next segment 40 of piping and into an unvented mixer 42, which is preferably an inline static mixer.

In a preferred embodiment, the molten adipic acid stream 36 is at a temperature of about 170° C. and the molten HMD stream 34 is at about 70° C., and the pressure at the Y-junction 38 is about 150 psig. The inline static mixer is preferably a Kenics static mixer with 24 elements. The walls of the Y-junction and the inline mixer 42 are preferably kept at about 268° C. The residence time of the monomers in the mixer 42 is preferably between about 1-30 seconds, more preferably about 3 seconds. The polymerization mixture leaving the mixer 42 passes into an unvented pipe, allowing for example an additional 10-60 seconds of reaction time at 260° C. and 150 psig.

Although the process of the present invention can operate without the inclusion of water in the reactants, it is not required that the reactants be entirely anhydrous. For example, the HMD feed stream could contain as much as about 5% water by weight, and the adipic acid stream could contain as much as about 2% water by weight, and the process should still function properly. Reactant streams having such low concentrations of water are referred to herein as “essentially dry.”

Some reaction of the HMD and adipic acid occurs from the time they contact each other at the Y-junction 38 continuing through the time they enter the heat exchanger 44. The temperature and residence time employed in this portion of the process can be selected to cause complete polymerization by this point, or to prevent compete polymerization from occurring by this point. In the latter situation, the partial reaction product generated by the contacting of the monomers is referred to herein as the “prepolymer.” The prepolymer mass in the pipe downstream of the mixer 42 will typically be 60-90% converted to nylon 6, 6. No plugging should occur because the conditions employed prevent crystallization of low melting intermediates. It is important to optimum operation of the process that the piping 40 and mixer 42 be unvented, and that the pressure therein be relatively low, for example between about 0-500 psig, most preferably about 150 psig.

In the embodiment shown in FIG. 1, the prepolymer next passes through a heat exchanger 44 and into a vented prepolymer reactor 46. It is not critical that a heat exchanger be used here. Any required heat could instead be provided by internal heating coils within the reactor 46, or by jacket around the reactor. The heated prepolymer exiting the heat exchanger 44 preferably enters the reactor 46 at a point below the surface of the liquid material therein. Further polymerization can occur in this reactor 46, which is preferably a continuously stirred tank reactor. The reactor bottoms stream 48 optionally can be split into a recycle stream 50 and a second stream 52 that is routed for further processing. If recycle is used, the recycle stream 50 flowrate is preferably at least 15 times larger than the flowrate of fresh prepolymer feed to the reactor 46. The reactor 46 is preferably operated about 50% full of liquid material in order to provide a large vapor/liquid disengagement surface.

It is highly desirable in this process to provide backmixing of polymer endgroups, high surface area interface generation which facilitates devolitilization of the molten material, and high heat transfer rates which can rapidly increase the temperature of the melted material. These advantages can be achieved, for example, either by use of a continuously stirred tank reactor, or by use of a plug flow reactor together with recycle of the product stream.

The overhead stream 54 from the reactor 46 is vapor including steam (i.e., vaporized water produced by the polycondensation reaction) and typically some HMD. The overhead 54 passes into an HMD recovery column 56, into which is also fed water 58. Condensate stream 60, containing some HMD and water, is recycled to the reactor 46, while the remaining vapor is cooled by a heat exchanger 62 and removed as part of an offgas stream 64.

In one embodiment, the prepolymer is heated to about 260° C. in the heat exchanger 44, and the reactor 46 operates at about 260° C. and 150 psig. As an example of suitable relative flowrates, if the fresh prepolymer is fed to the reactor 46 at a rate of 100 lbs. per hour, the reactor bottoms recycle flowrate is preferably about 2,000 lbs. per hour. A reactor 46 operated under these conditions can yield greater than 95% conversion of monomers to nylon 6, 6 with a three weight percent water concentration after 20 min. residence time in the reactor 46.

In accordance with the present invention, a control system is provided for adjusting the feed rate or mass flow rate of at least one of the molten dicarboxylic acid monomer and the molten diamine monomer to ensure a proper molar ratio in the polymerization mixture. In a preferred embodiment, the mass flow rate of at least one of the reactants is adjusted depending upon the balance of the carboxylic end groups and amine end groups within the polymerization mixture. This in-line end group measurement can be performed at any point downstream of the Y-junction 38. In the embodiment shown, this end group balance measurement is performed in the stream 52 leaving the reactor 46. Photospectrometry is the preferred methodology for measuring the balance of carboxyl and amine end groups within the polymerization mixture. In the preferred embodiment, a near-infrared (NIR) analyzer 66 detects the number of carboxyl and amine end groups in the polymerization mixture by assessing the spectral photometric content of the monomers therein.

In one embodiment, the control system of the present invention includes the near-infrared (NIR) device 66, a controller 67 receiving an input from the NIR analyzer 66, the HMD metering system 22, and the molten adipic acid metering system 32.

The NIR analyzer 66 is provided by way of example and not limitation as a device for determining the molar ratio of the molten dicarboxylic acid monomer and molten diamine monomer within the polymerization mixture. The NIR analyzer 66 achieves this by continuously detecting the number of carboxyl and amine end groups in the partially polymerized material leaving the reactor 46. Although employing the NIR analyzer 66 is preferred, it is contemplated control system of the present invention may be employed with any number of means for determining the molar ratio or molar balance of the molten dicarboxylic acid and molten diamine during polymerization

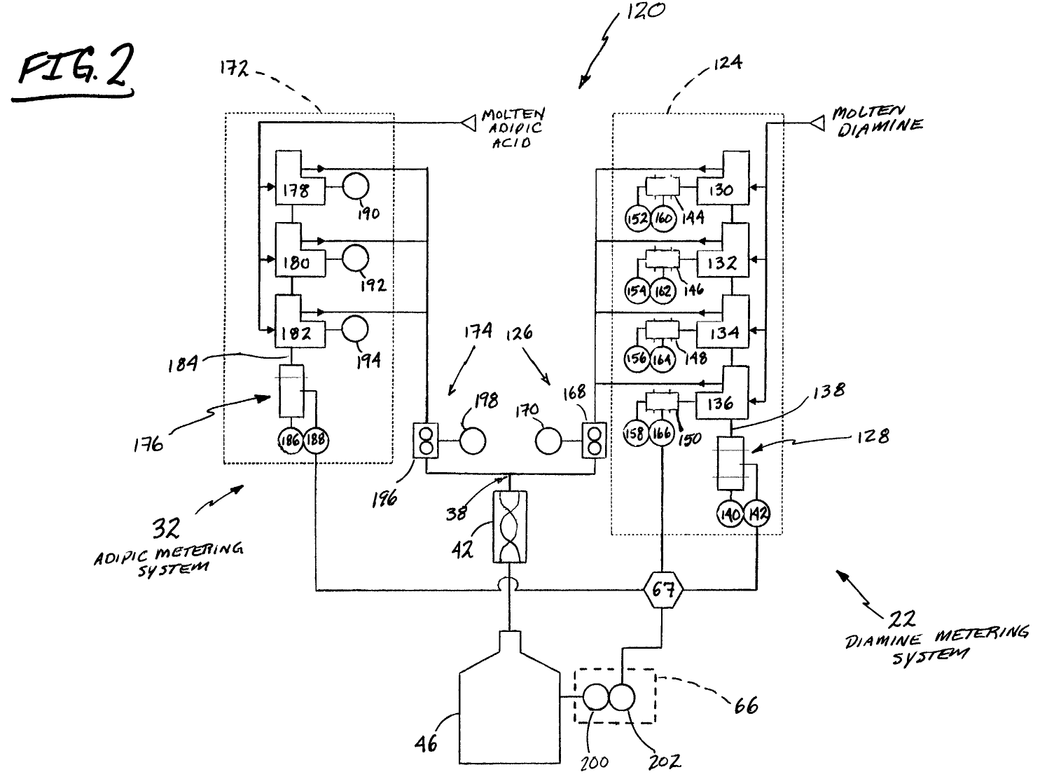

The NIR analyzer 66 generates an input signal to the controller 67 indicative of the balance of the carboxyl and amine end groups in the polymerization mixture. Using this input signal, the controller 67 can adjust the mass flow rate of the molten diamine monomer and/or the molten diamine monomer such that the polyamide formed by polymerizing the polymerization mixture will have a desired molar ratio. In a preferred embodiment, the controller 67 employs a feed forward control algorithm which varies the feed rate of the molten diamine monomer depending upon the input signal from the NIR analyzer 66. Using this feed forward control algorithm, the ratio of molten dicarboxylic acid monomer and molten diamine monomer may be controlled at the input to produce a polymerized end product having a predetermined molar ratio. In a preferred embodiment, this is accomplished by trimming the feed rate of the molten diamine monomer via the HMD metering system 22. The control and operation of the HMD metering system 22 and the molten adipic acid metering system 32 will be discussed in greater detail below with reference to FIGS. 2-4.

It should be noted that, although shown disposed along the stream 52, it is contemplated that the NIR analyzer 66 may be located at any point downstream from the Y-junction 38. For example, the NIR analyzer 66 may be located within the reactor 46 at a point below the liquid level, between the static mixer 42 and the reactor 46, within the static mixer 42, or between the static mixer 42 and the Y-junction 38.

Although the material at this point in the process is polymerized, in some embodiments of the process the extent of the polymerization, and therefore the molecular weight and relative viscosity (RV) of the polymer, will not be as high as is desired for the final product. Therefore, the partially polymerized material can be passed through a flasher 68 to supply additional heat, and then into a second reactor 70. The purpose of the second reactor 70 is to permit further polymerization and thus to increase the molecular weight and RV of the product. The polymer product in the bottoms stream 72 from the second reactor should have the desired molecular weight for the end product. Preferably the temperature in the second reactor 70 is between about 260 and about 280° C., and the pressure is atmospheric.

HMD vapor and steam generated in the second reactor 70 are removed in an overhead stream 74 which enters a scrubber 76. A water stream 78 is also fed to this scrubber, so that the steam will be condensed and can be removed as a sewer water stream 80. Remaining vapor leaves the scrubber 76 in an overhead stream 82 and becomes part of the offgas stream 64.

The polymer product can either be sent through a pelletizer 84 or routed through a bypass line 86. If it is run through the pelletizer, the polymer pellets are then passed into a dryer 88. A nitrogen gas feed 90, a nitrogen blower 92, and a nitrogen heater 94 are used to supply nitrogen gas to the vessel 88, which dries the polymer pellets. The dried pellets passing out the bottom of the dryer 88 pass through a water spray cooler 96, a screener 98, and are moved by a blower 100 to a product storage area 102.

Referring now to FIG. 2, shown is a block diagram of a control system of a preferred embodiment of the present invention, designated generally at 120, for use in the improved polymerization system shown in FIG. 1. The control system 120 includes the molten diamine (HMD) metering system 22, the molten adipic acid metering system 32, the controller 67, and the NIR analyzer 66. The control system 120 serves to control the amount of molten adipic acid which is combined with the molten diamine at the Y-junction 38 to form the polymerization mixture which enters the static mixer 42 in route to the prepolymer reaction vessel 46.

The molten diamine metering system 22 includes a diamine meter pump 124 and a diamine flow meter assembly 126. In a preferred embodiment, the diamine meter pump 124 is a positive displacement pump having a main drive motor 128, a plurality of main pumping heads 130-134, and a trim head 136. The main drive motor 128 includes a drive shaft 138 which extends into each of the main pumping heads 130-134 and the trim head 136. Individual pistons (not shown) are disposed within the main pumping heads 130-134 and trim head 136. The pistons (not shown) are coupled to the drive shaft 138 to provide the positive displacement of molten diamine monomer from the molten diamine vessel 20 past the flow meter assembly 126 and onward to the Y-junction 38 for passage into the static mixer 42.

The main drive motor 128 also includes a speed encoder 140 and a speed controller 142 which collectively form a closed loop feedback system for controlling the speed of the main drive motor 128. The speed encoder 140 monitors the speed of the main drive motor 128 and transmits a signal indicative of motor speed to the controller 67. The speed controller 142 receives an input signal from the controller 67 to control the speed of the main drive motor 128.

The main pumping heads 130-134 are equipped with servo motors 144-148, stroke position encoders 152-156, and stroke position controllers 160-164. The servo motors 144-148 are coupled to the pistons (not shown) disposed within the respective main pumping heads 130-134. The stroke position encoders 152-156 monitor the shaft position of each servo motor 144-148 and transmit signals indicative of stroke volume (0-100%) to the controller 67. The stroke position controllers 160-164 receive input signals from the controller 67 to control the shaft position of the servo motors 144-148 to produce a predetermined stroke volume (0-100%) within the main pumping heads 130-134. The main pumping heads 130-134 are preferably capable of providing flow rates suitable to provide a sufficient capacity of molten diamine to the system depending upon the size of the application.

The trim head 136 is similarly equipped with a servo motor 150, a stroke position encoder 158, and a stroke position controller 166. The servo motor 150, stroke position encoder 158, and stroke position controller 166 cooperate in the same fashion as those found in the main pumping heads 130-134. The main distinction is that the trim head 136 has a substantially smaller flow rate capability than the main pumping heads 130-134. This is because the trim head 136 is employed to supply relatively small flow rate of molten diamine to the larger flow rate from the main pumping heads 130-134 in the interest of fine-tuning the overall supply of molten diamine to the static mixer 42. As will be explained in greater detail below, this feature is significant in that it allows the control system 120 of the present invention alter the ratio of the initial reactants (molten adipic acid and molten diamine) prior to mixing such that the resulting polyamide has a stoichiometrically balanced molar ratio.

The flow meter assembly 126 of the molten diamine metering system 22 includes a flow meter 168 and a flow transmitter 170. The flow transmitter 170 is configured to monitor the flow rate of the molten diamine monomer as detected by the flow meter 168 and to simultaneously transmit an output signal to the controller 67 representing the diamine flow rate into the static mixer 42. The flow meter 168 and flow transmitter 170 may comprise any of a variety of commercially available flow meters and flow transmitters. Collectively, the flow meter assembly 126 and the diamine pump 124 cooperate with the controller 67 to form a closed loop feedback arrangement for selectively adjusting the flow rate of the molten diamine into the static mixer 42.

The molten adipic metering system 32 includes an adipic meter pump 172 and a flow meter assembly 174. In a preferred embodiment, the adipic meter pump 172 is a positive displacement pump having a main drive motor 176 and plurality of heads 178-182. The main drive motor 176 has a single drive shaft 184 extending into each of the heads 178-182. Individual pistons (not shown) are disposed within the heads 178-182 and coupled to the drive shaft 184 to provide the positive displacement of molten adipic acid from the adipic acid melter vessel 30 past the flow meter assembly 174 and onward to the Y-junction 38 for passage into the static mixer 42.

The main drive motor 176 also includes a speed encoder 186 and a speed controller 188 which collectively form a closed loop feedback system for controlling the speed of the main drive motor 176. The speed encoder 186 monitors the speed of the main drive motor 176 and transmits a signal indicative of motor speed to the controller 67. The speed controller 188 receives an input signal from the controller 67 to control the speed of the main drive motor 176. Manual stroke controllers 190-194 are provided for adjusting the stroke volume of the pistons within the heads 178-182, preferably between 0-100%.

The flow meter assembly 174 of the molten adipic acid metering system 32 includes a flow meter 196 and a flow transmitter 198. The flow transmitter 198 is configured to monitor the flow rate of the molten adipic acid monomer as detected by the flow meter 196 and to simultaneously transmit an output signal to the controller 67 representing the adipic acid flow rate into the static mixer 42. The flow meter 196 and flow transmitter 198 may comprise any of a variety of commercially available flow meters and flow transmitters.

The controller 67 is provided for receiving various input signals and outputting various control signals to coordinate the operation of the control system 120. The controller 67 should preferably be programmed to run according to a feed forward control algorithm. Under such a control scheme, the number of carboxyl and amine end groups are measured to determine the end group balance within the polymerization mixture. From this measurement, the controller 67 can employ a look-up table to determine to what extent the ratio of the initial reactants must be altered prior to mixing such that the reactants and resulting polyamide are provided having a stoichiometrically balanced molar ratio.

The NIR analyzer 66 includes an analyzer element 200 and an analyzer transmitter 202. The analyzer element 200 is coupled directly to the prepolymer reactor 46 for detecting the number of carboxyl and diamine end groups within the polymerization mixture as it exits from the prepolymer reactor 46. The analyzer transmitter 202 is coupled between the analyzer element 200 and the controller 67 for transmitting the output of the analyzer element 200 to the controller 67. The NIR analyzer 66 may comprise any number of commercially available near-infrared analyzers capable of assessing carboxylic and diamine end groups in the resulting polyamide.

The NIR analyzer 66 transmits an output signal to the controller 67 indicative of the molar balance of the unreacted monomers within the polymerization mixture. The controller 67 employs a feed forward control algorithm which varies the feed rate of the molten diamine monomer depending upon the output signal from the NIR analyzer 66. Using this feed forward control algorithm, the ratio of molten dicarboxylic acid monomer and molten diamine monomer may be controlled at the input to produce a polymerized end product having a stoichiometrically balanced molar ratio.

In one embodiment, this is accomplished by trimming the feed rate of the molten diamine monomer via the diamine metering system 22. The control and operation of the diamine metering system 22 and the molten adipic acid metering system 32 will be discussed in greater detail below with reference to FIGS. 2-4.

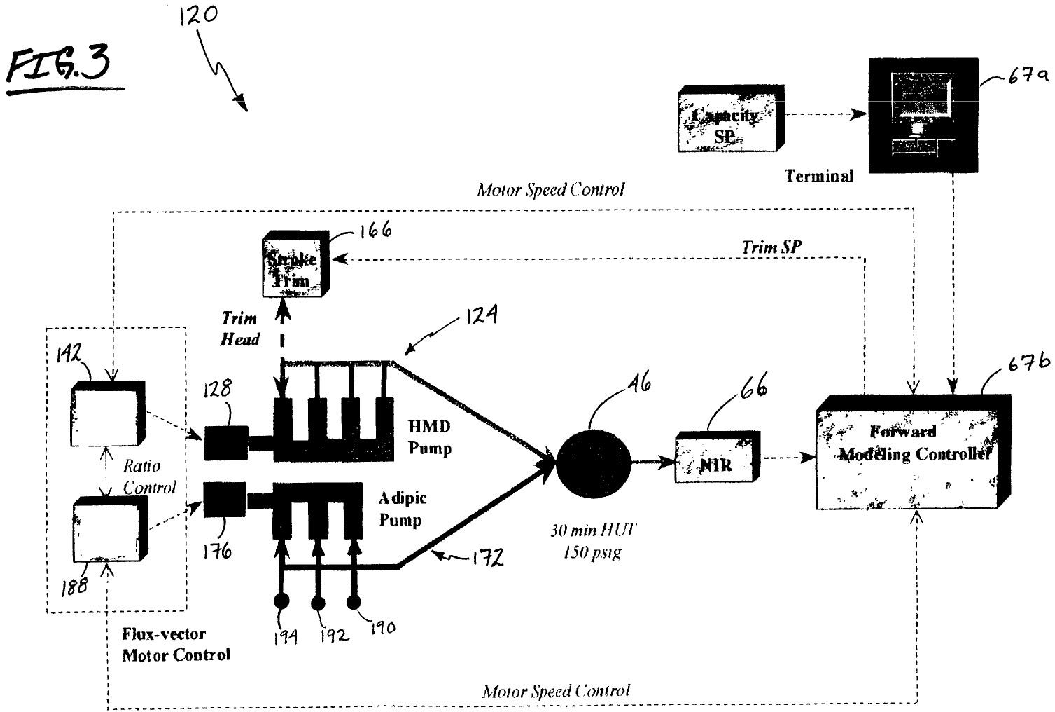

Referring to FIG. 3, the controller 67 may comprise any number of commercially available programmable controllers, including but not limited to a distributed control system (DCS), a programmable logic unit, or a microprocessor-based personal computer. The feed forward control arrangement employed in the controller 67 is possible because the components of the improved polyamidation system shown in FIG. 1 are predictable in terms of their characteristics and effect upon the polyamidation process. Namely, by eliminating the step of forming a salt via the addition of water, the present invention eliminates the need for evaporators in the polyamidation process. Evaporation vessels are unpredictable in terms of their effect on polyamidation and may exhibit wide variations during processing.

Operation of the control system 120 will now be described with combined reference to FIGS. 2 and 3. Referring first to FIG. 3, the initial step in the control system 120 involves having an operator input a set point (capacity SP) into the controller 67. For convenience, controller 67 is shown in FIG. 3 as including a terminal 67a for inputting the set point and a forward modeling controller 67b for managing the operation of the control system 120. After the user has input a desired set point (capacity SP), the computer terminal 67a transmits this information to the forward modeling controller 67b.

The forward modeling controller 67b then sets the motor speed control for the speed controller 188 for the main drive motor 176 of the adipic meter pump 172. In a preferred embodiment, the flow rate of the adipic acid metering system 32 is further controlled by manually adjusting the stroke controllers 190-194 such that molten adipic acid progresses to the static mixer 42 at a predetermined flow rate corresponding to the set point as selected by the operator. Once set, the flow rate of the molten adipic acid should preferably not be altered by the changing the control signal from the controller 67 or by adjusting the manual stroke controllers 190-194.

The forward modeling controller 67b also sets the motor speed control for the speed controller 142 associated with the main drive motor 128 of the diamine meter pump 124. The forward modeling controller 67b continuously monitors the output signal from the NIR analyzer 66 to obtain an assessment of the molar ratio of the molten dicarboxylic acid monomer and the molten diamine monomer within the polymerization mixture. In an important aspect, the forward modeling controller 67b uses this NIR output signal to generate and transmit a trim set point signal to the stroke position controller 166 of the servo motor 150 associated with the trim head 136. The trim set point signal transmitted to the stroke position controller 166 is generated based on a feed forward control algorithm found in the controller 67b. Such a feed forward control algorithm may take the form of a memory look-up table containing data representing the degree to which the ratio of reactants (molten adipic acid and molten diamine) must be varied to obtain the desired capacity set point selected by the operator based on the input from the NIR analyzer 66.

In the preferred embodiment, the flow rate of the diamine metering system 22 will be continually adjusted to provide the appropriate ratio of reactants (molten adipic acid and molten diamine) prior to mixing such that the resulting polyamide is provided having a stoichiometrically balanced molar ratio.

Referring to FIG. 2, the controller 67 accomplishes this by first controlling the main drive motor 128 and at least one of the servo motors 144-148 such that molten diamine is transmitted from the main pump heads 130-134 toward the static mixer 42. The controller 67 will then adjust the trim head 136 to fine tune the ratio of reactants being transferred into the static mixer 42. The trimming adjustment is based on the flow rate of the molten adipic acid (as measured by the flow meter assembly 174), the flow rate of the molten diamine (as measured by the flow meter assembly 126), the measurement of percentage weight of each reactant in the partially polymerized mixture within or following the reactor 46 (as measured by the NIR analyzer 66), and the stroke volume and motor speed information within the diamine meter pump 124 (as measured by the position encoders 152-158, the position controllers 160-166, the speed encoder 140, and speed controller 142).

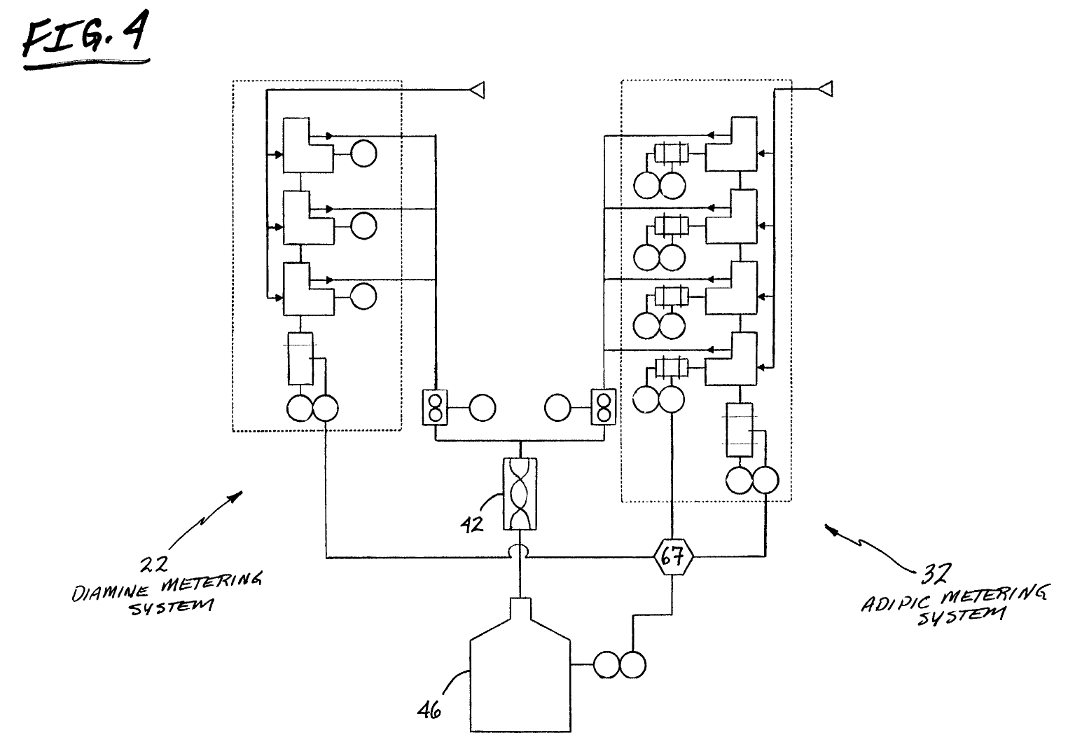

It is within the scope of the invention to employ the feed forward control algorithm where the mass flow rate of the molten bicarboxylic is adjusted based on the end group balance measurement. With reference to FIG. 4, the flow rate of the molten diamine monomer is maintained at a constant rate, while the bicarboxylic monomer is fine-tuned to produce the appropriate ratio of reactants to produce a desired capacity set point. As will be appreciated, the control circuitry shown in FIG. 4 is reversed from that shown in FIG. 2 such that a full discussion of the operation of the embodiment of FIG. 4 is not necessary.

The preceding description of specific embodiments of the present invention is not intended to be a complete list of every possible embodiment of the invention. Persons skilled in this field will recognize that modifications can be made to the specific embodiments described here that would be within the scope of the present invention. For example, although the detailed embodiments described herein react adipic acid and hexamethylenediamine to produce nylon 6, 6, other monomers known to those skilled in this field could be used to produce other polyamides.

What is claimed is:

1. A control system for producing a polyamide from a dicarboxylic acid monomer and a diamine monomer, comprising:
(a) first means for metering a supply of molten dicarboxylic acid monomer;
(b) second means for metering a supply of molten diamine monomer into said supply of molten dicarboxylic acid monomer to form a molten polymerization mixture;
(c) means for detecting the molar ratio of the molten dicarboxylic acid monomer and molten diamine monomer in the polymerization mixture; and
(d) a controller communicatively coupled to the means for detecting and at least one of the first and second means for metering, the controller controlling at least one of the first means for metering and the second means for metering based on a molar ratio input signal from the means for detecting to adjust the mass flow rate of at least one of the molten dicarboxylic acid monomer and the molten diamine monomer so as to balance the molar ratio of molten dicarboxylic acid monomer and molten diamine monomer in the polymerization mixture.

2. The control system of claim 1, wherein said means for detecting is a near-infrared analyzer for measuring the number of carboxyl monomer endgroups and diamine monomer endgroups in the molten polymerization mixture during polymerization.

3. The control system of claim 1 and further, said first means for metering including a first pump coupled to said supply of molten dicarboxylic acid monomer, and said second means for metering includes a second pump coupled to said supply of molten diamine monomer.

4. The control system of claim 1, wherein said dicarboxylic acid monomer is adipic acid, said diamine monomer is hexamethylenediamine, and said polyamide is nylon 6, 6.

5. A system for producing a polyamide from a dicarboxylic acid monomer and a diamine monomer, comprising:
(a) first metering means are provided for metering a supply of molten dicarboxylic acid monomer;
(b) second metering means are provided for metering a supply of molten diamine monomer, the first and second metering means being coupled together such that the supply of molten dicarboxylic acid monomer and the supply of molten diamine monomer combine to form a molten polymerization mixture;
(c) at least one unvented reaction vessel for polymerizing the polymerization mixture;
(d) means for detecting the molar ratio of molten dicarboxylic acid monomer and molten diamine monomer in the polymerizing mixture; and
(e) control means communicatively coupled to the means for detecting and the first and second metering means, the control means adjusting the mass flow rate of at least one of the supply of molten dicarboxylic acid monomer and the molten diamine monomer to balance the molar ratio of molten dicarboxylic acid monomer and molten diamine monomer in the polymerization mixture.

6. The system of claim 5, wherein the dicarboxylic acid monomer is adipic acid, the diamine monomer is hexamethylenediamine, and the polyamide is nylon 6, 6.
